(19) United States
(12) Patent Application Publication
(10) Pub. No.: US 2007/0034469 A1
(43) Pub. Date: Feb. 15, 2007

(54) High cooling efficiency and durable TCC for constant slip application

(75) Inventors: Shiqi Zhu, Wadsworth, OH (US); Kunding Wang, Copley, OH (US); Yongfu Liu, Wadsworth, OH (US); Jean-Francois Heller, Strassburg (FR)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/503,692

(22) Filed: Aug. 14, 2006

Related U.S. Application Data
(60) Provisional application No. 60/708,407, filed on Aug. 15, 2005.

(51) Int. Cl. F16H 45/02

(52) U.S. Cl. 192/3.29; 192/113.36

(57) ABSTRACT

A torque converter clutch for a constant slip application including a cover, a friction plate secured to the cover, and at least one channel between the cover and the friction plate. In another embodiment, the torque converter clutch may further include a one-way valve operatively arranged to permit a fluid to flow out of a channel, while preventing the fluid from flowing in through the channel.

### CROSS-REFERENCE TO RELATED APPLICATIONS

This patent application claims the benefit under 35 U.S.C. §119(e) of U.S. Provisional Application No. 60/708,407, filed Aug. 15, 2005, which application is incorporated herein by reference.

### FIELD OF THE INVENTION

The present invention relates generally to torque converter clutches, more particularly, to a torque converter clutch for a constant slip application, and, more specifically, to a durable, high cooling efficiency torque converter clutch for a constant slip application.

### BACKGROUND

Hydraulic torque converters, devices used to change the ratio of torque to speed between the input and output shafts of the converter, revolutionized the automotive and marine propulsion industries by providing hydraulic means to transfer energy from an engine to a drive mechanism, e.g., drive shaft or automatic transmission, while smoothing out engine power pulses. A torque converter includes three primary components, an impeller, sometimes referred to as a pump, directly connected to the engine's crankshaft, a turbine, similar in structure to the impeller, however the turbine is connected to the input shaft of the transmission, and a stator, located between the impeller and turbine, which redirects the flow of hydraulic fluid exiting from the turbine thereby providing additional rotational force to the pump. This additional rotational force results in torque multiplication. Thus, for example, when the impeller speed is high and the turbine speed is low, torque may be multiplied by a 2:1 or higher ratio, whereas when the impeller and turbine speeds are approximately the same, torque can be transferred at about a 1:1 ratio.

Although torque can be transferred at approximately a 1:1 ratio, there remains an amount of slippage between the impeller and turbine. Slippage results in lower fuel efficiency and therefore is less desirable. The push for increased fuel economy and gas mileage encouraged the development of torque converters having a clutch, i.e., a lock-up mechanism. When the speed of a vehicle having a torque converter clutch reaches a predetermined level, e.g., 40 miles per hour, hydraulic fluid in the stator shaft is pressurized, activating the clutch piston, which locks the torque converter output shaft to the converter housing, and thus connecting the engine output shaft to the transmission input shaft. The activated clutch piston, i.e., an engaged clutch, eliminates slippage, and thus improves fuel economy and gas mileage.

More recently, slipping clutches have been included in torque converter designs, as similar benefits to a locking system may be realized. Slipping clutches may be engaged sooner, i.e., at a lower engine speed or rotations per minute (RPM), as a result of the superior drivetrain isolation achieved with a slipping system. A result of the aforementioned non-locking system is that the clutch piston is constantly slipping along the housing cover. As is well-known, when two surfaces slip with respect to each other, frictional forces promote the generation of heat energy. An increase in temperature of the torque converter, and thus the hydraulic fluid within the converter, accelerates the degradation of both the fluid and the friction material used between the piston and the converter housing. Hence, since the introduction of torque converters having a slipping mechanism, the need to dissipate heat energy from the torque converter clutch has also existed.

Various methods and apparatus have been employed to minimize the increase in torque converter clutch temperature. For example, U.S. Pat. No. 4,423,803 (Malloy) teaches a torque converter clutch having a temperature regulator valve. Once hydraulic fluid in the apply chamber reaches a predetermined temperature, a bi-metallic valve opens, thereby permitting hydraulic fluid to flow between the apply chamber and the release chamber. Thus, the increased flow of fluid between the two chambers provides cooling for the clutch mechanism.

Additionally, grooves within the friction material or converter housing have been included to permit fluid flow from the apply chamber to the release chamber. Similar to the aforementioned bimetallic valve arrangement, heat is transferred away from the clutch region. However, both groove configurations have drawbacks. When grooves are formed within the friction material, they must be sufficiently deep to permit flow over an extended period of time, as the material wears away with use. Additionally, friction materials are typically poor conductors of heat energy and therefore can not be used to effectively remove heat from the torque converter clutch. Lastly, grooves in the cover have the tendency to prematurely wear the friction material, i.e., a cheese grater effect.

As can be derived from the variety of devices and methods directed at removing heat from the torque converter clutch, many means have been contemplated to accomplish the desired end, i.e., lengthy fluid and part life, without sacrificing the higher fuel efficiency and gas mileage afforded by a lock-up mechanism. Heretofore, tradeoffs between fluid and/or part life and fuel efficiency were required. Thus, there has been a longfelt need for a torque converter clutch having high cooling efficiency and durability.

### BRIEF SUMMARY OF THE INVENTION

The present invention broadly includes a torque converter clutch having a cover and a friction plate, wherein the friction plate is secured to the cover, and at least one channel, having a channel input and a channel output, located between the friction plate and the cover. In one embodiment the friction plate is welded to the cover, while in another embodiment the friction plate and cover are secured by brazing, and in yet another embodiment the friction plate and cover are secured by an adhesive material. The at least one channel is operatively arranged to allow hydraulic fluid to flow between the cover and friction plate, thereby drawing heat away from the torque converter clutch. In yet another embodiment, the at least one channel includes a one-way valve operatively arranged to permit hydraulic fluid to flow out of the channel through the channel output, while preventing fluid from flowing into the channel output.

A general object of the invention is to enable efficient transfer of heat away from a torque converter clutch.

Another object of the invention is to extend the useful life of a torque converter clutch by preventing the deterioration of friction material and/or hydraulic fluid.

These and other objects, features, and advantages of the present invention will become readily apparent to one having ordinary skill in the art upon reading the detailed description of the invention in view of the drawings and appended claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a torque converter;

FIG. 2 is a cross-sectional view of the torque converter shown in FIG. 1, taken generally along line 2-2 of FIG. 1;

FIG. 3A is a front elevational view of a cover and friction plate of the present invention having internally located channels with channel inputs proximate other channel inputs;

FIG. 3B is a front elevational view of a cover and friction plate of the present invention having internally located channels with channel inputs proximate channel outputs;

FIG. 4 is a perspective view of the friction plate of the present invention showing a plurality of channels;

FIG. 5 is a cross-sectional view of the friction plate shown in FIG. 4, taken generally along line 5-5 of FIG. 4; and,

FIG. 6 is an enlarged cross-sectional view of an embodiment of the cover and friction plate of the present invention shown in the encircled region 6 of FIG. 2 having a one-way valve operatively arranged at a channel output.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred embodiment, it is to be understood that the invention as claimed is not limited to the preferred embodiment.

Furthermore, it is understood that this invention is not limited to the particular methodology, materials and modifications described and as such may, of course, vary. It is also understood that the terminology used herein is for the purpose of describing particular embodiments only, and is not intended to limit the scope of the present invention.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

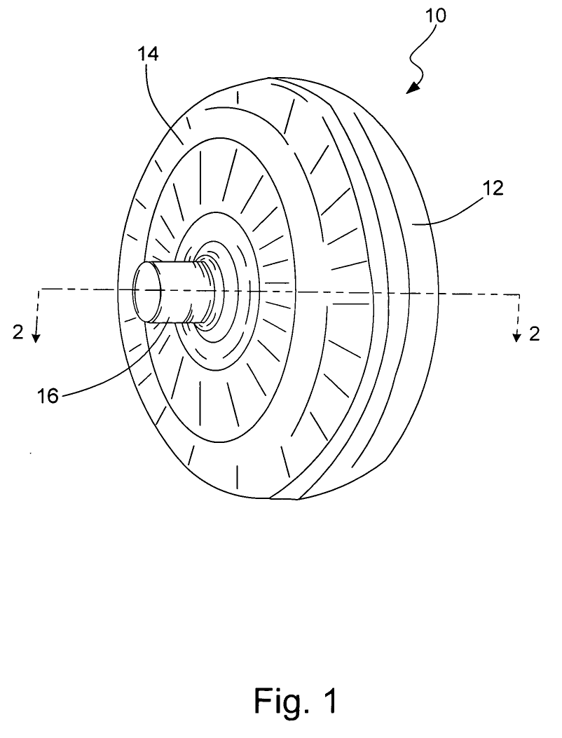

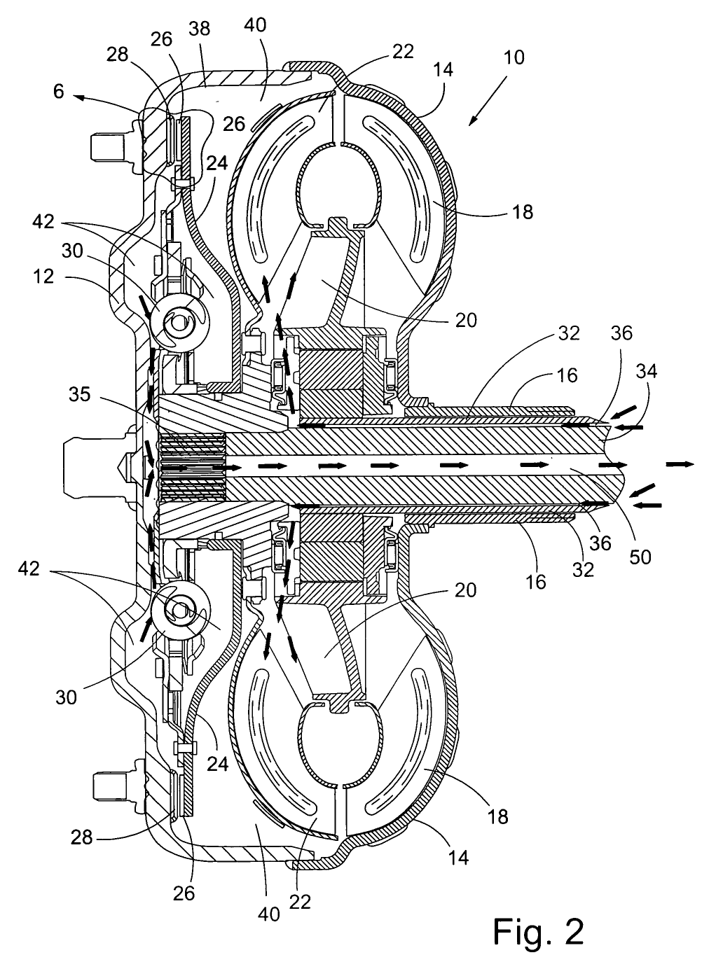

Adverting now to the figures, FIG. 1 shows a perspective view of torque converter 10. Torque converter 10 includes first housing cover 12, second housing cover 14, and housing hub 16. In a preferred embodiment, torque converter 10 is operatively arranged to transfer torque between an engine and a transmission, as described supra. Thus, converter 10 is positioned so that first housing cover 12 may be coupled to a flywheel of the engine (not shown), stator shaft 32 (see FIG. 2) may be coupled to a fixed transmission mount (not shown), and transmission input shaft 34 (see FIG. 2) may be engaged with turbine hub 35 (see FIG. 2). Because converter 10 is fixedly secured to the engine flywheel, converter 10 rotates as the flywheel rotates. The result of such rotation is described above, and further described infra. As the engine and transmission are not particularly germane to this invention, they are not discussed in detail.

FIG. 2 shows a cross-sectional view of torque converter 10, taken generally along line 2-2 of FIG. 1. Converter 10 generally includes first and second housing covers 12 and 14, respectively, wherein pump 18, stator 20, turbine 22, piston 24 which includes friction material 26, friction plate 28, damper 30, stator shaft 32, transmission input shaft 34, and turbine hub 35 are located. Hydraulic fluid (shown as arrows) enters converter 10 through first cavity 36, the volume created between the inner wall of stator shaft 32 and the outer wall of transmission input shaft 34, and subsequently pressurizes the fluid volume contained within piston 24 and first and second housing covers 12 and 14, respectively, i.e., apply cavity 40. Although fluid entry and pressurization, in this embodiment, is described as occurring through first cavity 36, one of ordinary skill in the art recognizes that such entry and pressurization may also occur in the volume between housing hub 16 and stator shaft 32. Due to the rotation of converter 10, the hydraulic fluid is transferred via centrifugal force from pump 18 to turbine 22, whereby engine torque is also transmitted to turbine 22. As a result of the shape of turbine 22, the hydraulic fluid is then returned to pump 18, through stator 20. Stator 20 alters the flow direction of the hydraulic fluid thereby improving the torque multiplication of converter 10.

As described supra, torque converters may include lock-up mechanisms to provide improved efficiency and gas mileage. In the embodiment shown in FIG. 2, converter 10 includes friction plate 28 fixedly secured to inner surface 38 of first housing cover 12. In a preferred embodiment friction plate 28 is welded to inner surface 38, however as one of ordinary skill in the art appreciates, other means of securing are possible, e.g., brazing and adhesives, and such other means are within the metes and bounds of the invention as claimed. Piston 24 including friction material 26 comprise the lock-up mechanism of converter 10 and are fixedly secured to damper 30. Damper 30 is operatively arranged to reduce vibration conducted from the engine to the transmission (not shown).

Throughout operation, pressurized hydraulic fluid fills apply and release cavities 40 and 42, respectively. At initial startup or under conditions when it is inappropriate to lock turbine shaft 34 to first housing cover 12, the lock-up mechanism is not engaged. Therefore, hydraulic fluid pressure in apply and release cavities 40 and 42, respectively, is typically low, e.g., 30 pounds per square inch, and approximately equal. As torque converter 10 and turbine shaft 34 approach a predetermined rotational rate with respect to each other, and the vehicle having such torque converter approaches a predetermined velocity, the hydraulic fluid pressure in apply cavity 40 is increased, e.g., 150 pounds per square inch, whereby piston 24 and friction material 26 are releasably engaged with friction plate 28. Under the aforementioned lock-up condition, and more specifically due to frictional forces between friction plate 28 and friction material 26, the vehicle engine is directly connected to the transmission and thus the vehicle's efficiency and gas mileage are improved. As converter 10 is brought under conditions that are not conducive for lock-up, e.g., the vehicle begins to slow in velocity, hydraulic fluid pressure in apply cavity 40 is reduced, and subsequently the constant pressure contained within release cavity 42, being sufficient to overcome the reduced pressure in apply cavity 40, causes friction material 26 to release from friction plate 28.

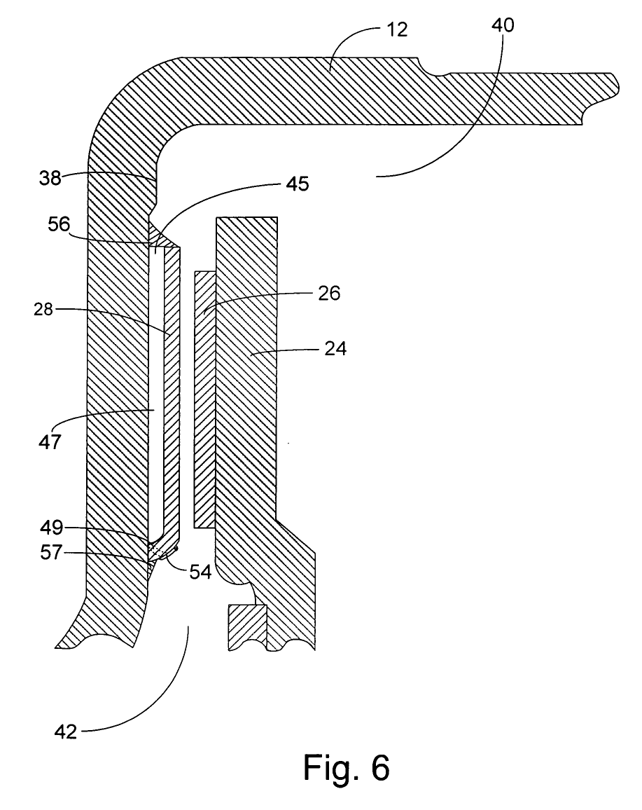

Typically, while the lock-up mechanism is engaged, no hydraulic fluid is permitted to flow from apply cavity 40 to release cavity 42. Hence, when converter 10 is under slipping conditions, heat energy may build up within the hydraulic fluid in apply cavity 40, thereby promoting the aforementioned fluid degradation. Thus, in this embodiment, friction plate 28 having channel input 44, channel 46 and channel output 48 (see FIG. 6), permits the flow of hydraulic fluid from apply cavity 40 to release cavity 42, thereby removing heat energy from friction plate 28 via the hydraulic fluid. As friction plate 28, in a preferred embodiment, is constructed from metal material, and metal being an efficient conductor of heat, the heat energy generated between friction plate 28 and friction material 26 may be substantially removed from this area by flowing hydraulic fluid through channel 46. Upon exiting channel 46 through channel output 48, the fluid enters release cavity 42, and subsequently exits converter 10 through second cavity 50, a bore located along the central axis of turbine shaft 34. After the hydraulic fluid exits converter 10, it may be cooled and then reintroduced through first cavity 36 as described supra.

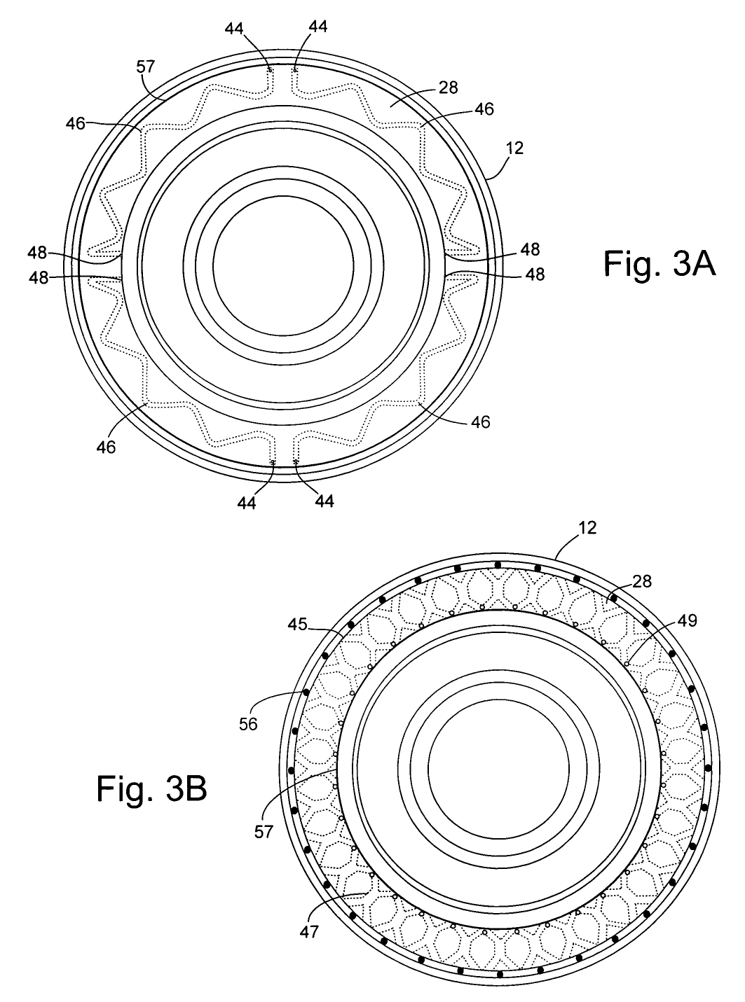

FIG. 3A shows a front elevational view of cover 12 and friction plate 28 having channels 46 with channel inputs 44 and channel outputs 48. In this embodiment, friction plate 28 is fixedly secured to cover 12 by continuous weld 57. As continuous weld 57 seals the circumference of friction plate 28, entrance of hydraulic fluid into channel 46 is limited by channel input 44. Furthermore, in this embodiment, channel inputs 44 are operatively arranged so that each input 44 is proximate another input 44, and all inputs 44 are located adjacent the outer radius of friction plate 28, i.e., proximate continuous weld 57. Additionally, as maintaining the tolerances of depth and width of channels 46 may be difficult during manufacture, in this embodiment the rate of hydraulic fluid flow within channel 46 is controlled by the diameter of channel input 44. Although the manufacturing reproducibility of the diameter of channel input 44 is more easily maintained, and thus is typically the means of controlling rate of fluid flow, it is within the scope of this invention to control the size and shape of channel 46 or the diameter of channel output 48, and thereby fix the rate of fluid flow through channel 46. It will also be appreciated by one of ordinary skill in the art that although channels 46 are depicted as zig-zag patterns, any pattern connecting channel input 44 with channel output 48 is possible, e.g., straight line or complex lattice, and such variations are within the scope of the invention.

FIG. 3B shows a front elevational view of another embodiment of cover 12 and friction plate 28 having channels 47 with channel inputs 45 and channel outputs 49. In this embodiment, channels 47 comprise a honeycomb pattern, wherein hydraulic fluid is transferred from inputs 45 to outputs 49. Thus, the rate of hydraulic fluid flow through channel 47 is controlled by the diameter of outputs 49. Contrary to the embodiment shown in FIG. 3A, in this embodiment friction plate 28 is fixedly secured to cover 12 by spot-welds 56 and continuous weld 57 about the outer and inner circumferences of plate 28, respectively. As described supra, other configurations of channel construction, e.g., straight lines or zig-zag patterns, as well as controlling the rate of fluid flow by maintaining the tolerances of channel 47 or the size of inputs 45, are within the scope of the invention as claimed.

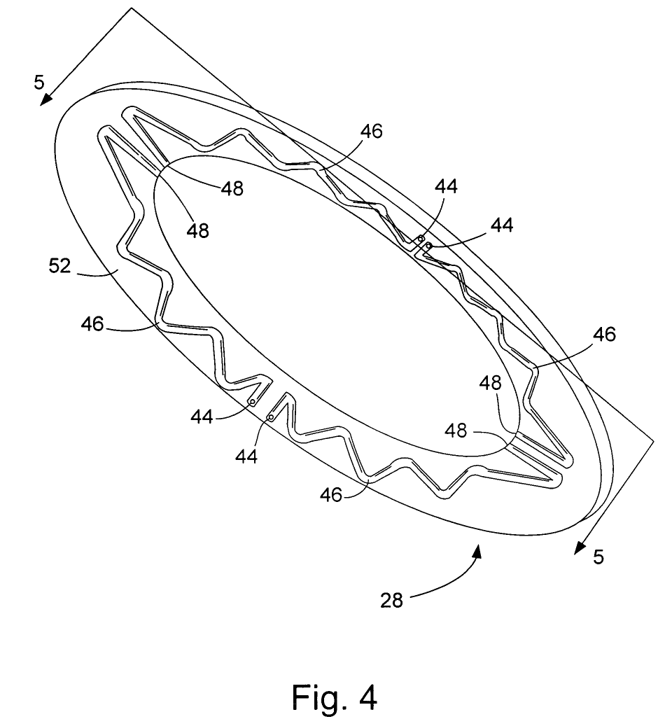

FIG. 4 is a perspective view of friction plate 28 showing a plurality of channels 46 according to FIG. 3A. In this embodiment, channels 46 are formed within surface 52 of friction plate 28. Subsequently, plate 28 is fixedly secured to first housing cover 12, as described above, having surface 52 of friction plate 28 in contact with surface 38 of first housing cover 12. Although in this embodiment channels 46 are formed in surface 52, one of ordinary skill in the art will appreciate that channels 46 may also be formed within first housing cover 12. Thus, channel inputs 44 must merely be aligned to the channels formed in first housing cover 12, prior to fixedly securing friction plate 28 to cover 12 with continuous weld 57 (see FIG. 3A).

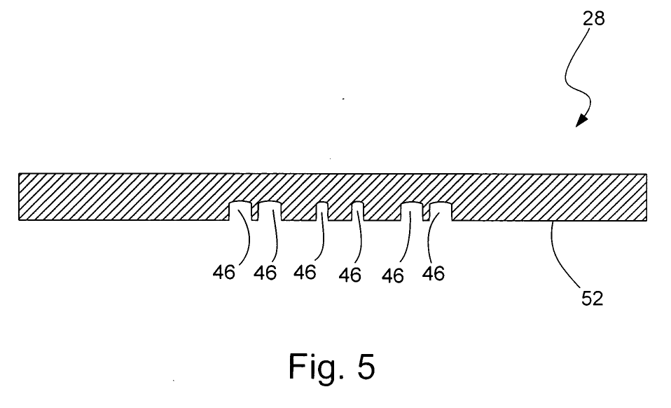

FIG. 5 is a cross-sectional view of friction plate 28, taken generally along line 5-5 of FIG. 4. Although in the embodiments disclosed, the rate of fluid flow within channel 46 is primarily controlled by the diameter of channel input 44, in part the rate of flow may be controlled by the width and depth of channel 46. Thus, by forming a wider and/or deeper channel 46, the resistance to fluid flow within channel 46 may be decreased and therefore less pressure within apply cavity 40 (see FIG. 2) is required to drive the fluid through channel 46 to release cavity 42.

FIG. 6 is an enlarged cross-sectional view of an embodiment of cover 12 and friction plate 28 of the present invention shown in the encircled region 6 of FIG. 2, and also shown in the front elevational view of FIG. 3B. This embodiment further includes one-way valve 54 operatively arranged at channel output 49. As described supra, friction plate 28 may be fixed secured to first housing cover 12 by spot-welds 56 and continuous weld 57, whereby channels 47 are sealed, thus limiting fluid entrance and exit to channel inputs 45 and channel outputs 49, respectively. In this embodiment, one-way valve 54 precludes fluid flowing from release cavity 42 to apply cavity 40. Hence, when one-way valve 54 is incorporated in the instant invention, and the lock-up mechanism is engaged, hydraulic fluid may only flow from apply cavity 40 to release cavity 42, and flow is prevented in the opposite direction. Although not depicted, the instant invention may also be used without one-way valve 54, and as such, the pressure differential between apply and release chambers 40 and 42, respectively, controls the direction of flow within channels 47.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A torque converter clutch for a constant slip application comprising:
a cover;
a friction plate fixedly secured to said cover; and,
at least one channel located between said friction plate and said cover.

2. The torque converter clutch for a constant slip application of claim 1 wherein said at least one channel is formed by at least one first groove within the cover.

3. The torque converter clutch for a constant slip application of claim 1 wherein said at least one channel is formed by at least one second groove within the friction plate.

4. The torque converter clutch for a constant slip application of claim 1 wherein said at least one channel is formed by at least one third groove within the cover and the friction plate.

5. The torque converter clutch for a constant slip application of claim 1 wherein said at least one channel further comprises a plurality of channels, wherein each channel in said plurality of channels has a respective input and output.

6. The torque converter clutch for a constant slip application of claim 5 wherein said respective input for each channel in said plurality of channels is proximate said respective input for another channel in said plurality of channels.

7. The torque converter clutch for a constant slip application of claim 5 wherein said respective input for each channel in said plurality of channels is proximate said respective output for another channel in said plurality of channels.

8. The torque converter clutch for a constant slip application of claim 1 wherein said at least one channel comprises a one-way valve.

9. The torque converter clutch for a constant slip application of claim 8 wherein said valve is operatively arranged to enable fluid flow out of said at least one channel and to prevent fluid flow into said at least one channel.

10. The torque converter clutch for a constant slip application of claim 9 wherein said at least one channel has an output and said valve is operatively arranged at said output.

11. The torque converter clutch for a constant slip application of claim 1 wherein said friction plate is fixedly secured to said cover by a welding means.

12. The torque converter clutch for a constant slip application of claim 1 wherein said friction plate is fixedly secured to said cover by a brazing means.

13. The torque converter clutch for a constant slip application of claim 1 wherein said friction plate is fixedly secured to said cover by an adhesive material.

14. The torque converter clutch for a constant slip application of claim 1 wherein said clutch further comprises a fluid and said at least one channel is configured to enable flow of said fluid through said at least one channel.

15. The torque converter clutch for a constant slip application of claim 14 wherein flow of said fluid has a first rate and said at least one channel is operatively arranged to control said first rate.

16. The torque converter clutch for a constant slip application of claim 14 wherein flow of said fluid has a second rate, said at least one channel further comprises an input and output, and said input or output is operatively arranged to control said second rate.

17. The torque converter clutch for a constant slip application of claim 1 wherein said clutch further comprises a second fluid and said at least one channel further comprises an input and output, said input or output is configured to enable said second fluid to flow through said at least one channel.

18. A torque converter clutch for a constant slip application comprising:
a cover and a friction plate fixedly secured to said cover;
at least one channel located between said friction plate and said cover; and,
at least one one-way valve operatively arranged to enable fluid flow out of said at least one channel, while preventing fluid flow into said at least one channel.

19. The torque converter clutch for a constant slip application of claim 18 wherein said at least one channel has an output, and said valve is operatively arranged at said output.

20. The torque converter clutch for a constant slip application of claim 18 wherein said clutch further comprises a fluid and said at least one channel is configured to enable flow of said fluid through said at least one channel.

21. The torque converter clutch for a constant slip application of claim 20 wherein flow of said fluid has a first rate and said at least one channel is operatively arranged to control said first rate.

22. The torque converter clutch for a constant slip application of claim 20 wherein flow of said fluid has a second rate, said at least one channel further comprises an input and output, and said input or output is operatively arranged to control said second rate.
